(19) United States
(12) Patent Application Publication
(10) Pub. No.: US 2014/0165173 A1
(43) Pub. Date: Jun. 12, 2014

(54) Mediation Server, Control Method Therefor, Subscription Information Managing Apparatus, Control Method Therefor, Subscription Management Server, and Control Method Therefor

(71) Applicants: Johan Hjelm, Tokyo (JP); Ryoji Kato, Kanagawa (JP); Shingo Murakami, Kanagawa (JP); Toshikane Oda, Tokyo (JP); Shinta Sugimoto, Kanagawa (JP)

(72) Inventors: Johan Hjelm, Tokyo (JP); Ryoji Kato, Kanagawa (JP); Shingo Murakami, Kanagawa (JP); Toshikane Oda, Tokyo (JP); Shinta Sugimoto, Kanagawa (JP)

(73) Assignee: TELEFONAKTIEBOLAGET L M ERICSSON (PUBL), Stockholm (SE)

(21) Appl. No.: 14/131,213

(22) PCT Filed: Jul. 27, 2011
(86) PCT No.: PCT/SE2011/050972

§ 371 Date: Jan. 7, 2014

(51) Int. Cl. H04L 29/06

(52) U.S. Cl. CPC H04L 63/08
USPC 726/7

(57) ABSTRACT

There is provided a mediation server. The mediation server comprises, among other things, a device identity receiving unit configured to receive, from a communication device, a device identity which enables the communication device to connect to a network operated by a network operator associated with the mediation server, a login request sending unit configured to send, to the communication device, a login request for requesting login credentials for one of at least one user identity associated with the device identity, and a login credentials receiving unit configured to receive the login credentials from the communication device. The mediation server also comprises a subscription information relaying unit configured to obtain subscription information for use by the communication device from a selected network, and forward the obtained subscription information to the communication device.

### TECHNICAL FIELD

The present invention generally relates to a technique for enabling a mediation server to identify a user of a communication device during the procedure of providing the communication device with subscription information such as a Machine Communication Identity Module (MCIM).

### BACKGROUND

The 3rd Generation Partnership Project (3GPP) discusses remote provisioning of subscription information for Machine-to-Machine Equipment (M2ME) (see 3GPP TR 33.812 V9.2.0). According to TR 33.812, an M2ME, which is a kind of a communication device, is provided with a temporary private identity called a Provisional Connectivity ID (PCID). The PCID follows the same format as an International Mobile Subscriber Identity (IMSI), and an authenticating party identified by the PCID is called a Registration Operator (RO). The M2ME accesses the RO using the PCID, and requests for subscription information called a Machine Communication Identity Module (MCIM). Upon request, the RO accesses a network operator called a Selected Home Operator (SHO), receives the MCIM issued by the SHO, and forwards the MCIM to the M2ME.

In this way, the M2ME is able to obtain the MCIM from the SHO via the RO using the PCID just one time, and thereafter, the M2ME is able to attach to a 3GPP access network using the MCIM.

The mechanism of TR 33.812 is convenient for a user of a communication device in that it is possible for the user to obtain subscription information for the communication device via a network.

Although the term “M2ME” is used in TR 33.812, hereinafter the term “Connected Consumer Electronics (CCE)” is used in place of the term “M2ME” because communication devices that can be provided with an MCIM are not limited to a “machine-to-machine” communication device.

Meanwhile, a PCID is associated with subscription, and therefore, an RO can identify the associated subscriber when a CCE accesses the RO by use of the PCID. However, a user of the CCE is not necessarily the same as the subscriber. For example, assuming that a company purchases a CCE and makes subscription for a PCID of the CCE, and employees of the company share the CCE. In this case, the subscriber is the company, whereas the user of the CCE is one of the employees. Accordingly, although the RO can identify the subscriber of the PCID of the CCE during the procedure of MCIM provisioning, the RO cannot identify the current user of the CCE.

A similar problem also happens in scenarios where an embedded Subscriber Identity Module (SIM) is activated using Over The Air (OTA) provisioning, which is described as such in the paper titled “Over-The-Air (OTA) technology” found at http://www.3gpp.org/ftp/tsg_sa/wg3_security/TSGS3_{—}30_Povoa/Docs/PDF/S3-030534.pdf.

### SUMMARY

The present invention is intended to address the above-described problem, and it is a feature thereof to introduce a technique for enabling a mediation server (e.g., a server implementing the functionality of an RO) to identify a user of a communication device (e.g., a CCE) during the procedure of providing the communication device with subscription information (e.g., an MCIM). Moreover, it is also a feature of the present invention to introduce a technique for enabling a subscription management server (e.g., a server associated with a mobile network operator (MNO)) to identify a user of a communication device (e.g., a CCE) during the procedure of activating subscription information (e.g., an embedded SIM).

According to the first aspect of the present invention, there is provided a mediation server. The mediation server comprises: a device identity receiving unit configured to receive, from a communication device, a device identity which enables the communication device to connect to a network operated by a network operator associated with the mediation server; a user identity obtaining unit configured to obtain at least one user identity associated with the device identity; a login request sending unit configured to send, to the communication device, a login request for requesting login credentials for one of the at least one user identity; a login credentials receiving unit configured to receive the login credentials from the communication device; a verifying unit configured to verify the login credentials by comparing the login credentials with login credentials associated with the one of the at least one user identity; an identifying unit configured to, if the login credentials are successfully verified, identify, based on the one of the at least one user identity, network operators that offer to provide the communication device with subscription information which enables the communication device to connect to a network operated by the network operator; a list sending unit configured to send a list of the identified network operators to the communication device; a selection information receiving unit configured to receive selection information indicating one of the network operators in the list from the communication device; and a subscription information relaying unit configured to obtain subscription information for use by the communication device from the network operator indicated by the selection information, and forward the obtained subscription information to the communication device.

According to the second aspect of the present invention, there is provided a method for controlling a mediation server. The method comprises: a device identity receiving step of receiving, from a communication device, a device identity which enables the communication device to connect to a network operated by a network operator associated with the mediation server; a user identity obtaining step of obtaining at least one user identity associated with the device identity; a login request sending step of sending, to the communication device, a login request for requesting login credentials for one of the at least one user identity; a login credentials receiving step of receiving the login credentials from the communication device; a verifying step of verifying the login credentials by comparing the login credentials with login credentials associated with the one of the at least one user identity; an identifying step of, if the login credentials are successfully verified, identifying, based on the one of the at least one user identity, network operators that offer to provide the communication device with subscription information which enables the communication device to connect to a network operated by the network operator; a list sending step of sending a list of the identified network operators to the communication device; a selection information receiving step of receiving selection information indicating one of the network operators in the list from the communication device; and a subscription information relaying step of obtaining subscription information for use by the communication device from the network operator indicated by the selection information, and forwarding the obtained subscription information to the communication device.

According to the third aspect of the present invention, there is provided a subscription information managing apparatus for use in a communication device. The subscription information managing apparatus comprises: a subscription information maintaining unit configured to store a device identity which enables the communication device to connect to a network operated by a network operator associated with a mediation server; a device identity sending unit configured to send the device identity to the mediation server; a login request relaying unit configured to receive, from the mediation server, a login request for requesting login credentials for a certain user identity associated with the device identity, and forward the received login request to the communication device; a login credentials relaying unit configured to receive the login credentials from the communication device, and forward the received login credentials to the mediation server; a list relaying unit configured to receive, from the mediation server, a list of network operators identified by the mediation server based on the certain user identity, and forward the list to the communication device; a selection information relaying unit configured to receive, from the communication device, selection information indicating one of the network operators in the list, and forward the received selection information to the mediation server; and a provisioning unit configured to receive, from the mediation server, subscription information which enables the communication device to connect to a network operated by the network operator indicated by the selection information, and provision the received subscription information in the subscription information maintaining unit.

According to the fourth aspect of the present invention, there is provided a method for controlling subscription information managing apparatus for use in a communication device. The subscription information managing apparatus has a subscription information maintaining unit configured to store a device identity which enables the communication device to connect to a network operated by a network operator associated with a mediation server. The method comprises: a device identity sending step of sending the device identity to the mediation server; a login request relaying step of receiving, from the mediation server, a login request for requesting login credentials for a certain user identity associated with the device identity, and forwarding the received login request to the communication device; a login credentials relaying step of receiving the login credentials from the communication device, and forwarding the received login credentials to the mediation server; a list relaying step of receiving, from the mediation server, a list of network operators identified by the mediation server based on the certain user identity, and forwarding the list to the communication device; a selection information relaying step of receiving, from the communication device, selection information indicating one of the network operators in the list, and forwarding the received selection information to the mediation server; and a provisioning step of receiving, from the mediation server, subscription information which enables the communication device to connect to a network operated by the network operator indicated by the selection information, and provisioning the received subscription information in the subscription information maintaining unit.

According to the fifth aspect of the present invention, there is provided a subscription management server. The subscription management server comprises: a detecting unit configured to detect a communication device which tries to connect to a network by use of subscription information issued by a network operator associated with the subscription management server; a user identity obtaining unit configured to obtain at least one user identity associated with the subscription information; a login request sending unit configured to send, to the communication device, a login request for requesting login credentials for one of the at least one user identity; a login credentials receiving unit configured to receive the login credentials from the communication device; a verifying unit configured to verify the login credentials by comparing the login credentials with login credentials associated with the one of the at least one user identity; and an authorizing unit configured to, if the login credentials are successfully verified, authorize the communication device to connect to the network by use of the subscription information.

According to the sixth aspect of the present invention, there is provided a method for controlling a subscription management server. The method comprises: a detecting step of detecting a communication device which tries to connect to a network by use of subscription information issued by a network operator associated with the subscription management server; a user identity obtaining step of obtaining at least one user identity associated with the subscription information; a login request sending step of sending, to the communication device, a login request for requesting login credentials for one of the at least one user identity; a login credentials receiving step of receiving the login credentials from the communication device; a verifying step of verifying the login credentials by comparing the login credentials with login credentials associated with the one of the at least one user identity; and an authorizing step of, if the login credentials are successfully verified, authorizing the communication device to connect to the network by use of the subscription information.

According to the seventh aspect of the present invention, there is provided a subscription information managing apparatus for use in a communication device. The subscription information managing apparatus comprises: a subscription information maintaining unit configured to store subscription information issued by a network operator associated with a subscription management server; a login request relaying unit configured to receive, from the subscription management server, a login request for requesting login credentials for a certain user identity associated with the subscription information, and forward the received login request to the communication device; and a login credentials relaying unit configured to receive the login credentials from the communication device, and forward the received login credentials to the subscription management server.

According to the eighth aspect of the present invention, there is provided a method for controlling a subscription information managing apparatus for use in a communication device. The subscription information managing apparatus has a subscription information maintaining unit configured to store subscription information issued by a network operator associated with a subscription management server. The method comprises: a login request relaying step of receiving, from the subscription management server, a login request for requesting login credentials for a certain user identity associated with the subscription information, and forwarding the received login request to the communication device; and a login credentials relaying step of receiving the login credentials from the communication device, and forwarding the received login credentials to the subscription management server.

By virtue of the first to fourth aspects of the present invention, the mediation server receives, from the communication device, login credentials for a certain user identity during the procedure of providing the communication device with subscription information. Accordingly, it is possible for the mediation server to identify the user of the communication device. Moreover, by virtue of the fifth to eighth aspects of the present invention, the subscription management server receives, from the communication device, login credentials for a certain user identity during the procedure of activating subscription information. Accordingly, it is possible for the subscription management server to identify the user of the communication device.

Further features of the present invention will become apparent from the following description of exemplary embodiments with reference to the attached drawings, in which like reference characters designate the same or similar parts throughout the figures thereof.

### BRIEF DESCRIPTION OF DRAWINGS

FIG. 1 illustrates an overview of an MCIM provisioning system 100 according to the first embodiment of the present invention;

FIG. 2 is a sequence diagram illustrating a procedure of MCIM provisioning according to the first embodiment of the present invention;

FIG. 3A illustrates an example of the display of the confirmation request including the advertisement;

FIG. 3B illustrates an example of the display of the login request including the advertisement;

FIG. 3C illustrates an example of the display of the list of network operators including the advertisement;

FIG. 4 is a functional block diagram of the mediation server 130 according to the first embodiment of the present invention;

FIG. 5 is a functional block diagram of the MBM 120 according to the first embodiment of the present invention;

FIG. 6 illustrates an overview of a SIM activating system 600 according to the second embodiment of the present invention;

FIG. 7 is a sequence diagram illustrating a procedure of activating an embedded SIM according to the second embodiment of the present invention;

FIG. 8A illustrates an example of the display of the confirmation request including the advertisement;

FIG. 8B illustrates an example of the display of the login request including the advertisement;

FIG. 9 is a functional block diagram of the subscription management server 640 according to the second embodiment of the present invention; and

FIG. 10 is a functional block diagram of the MBM 620 according to the second embodiment of the present invention.

### DETAILED DESCRIPTION

### First Embodiment

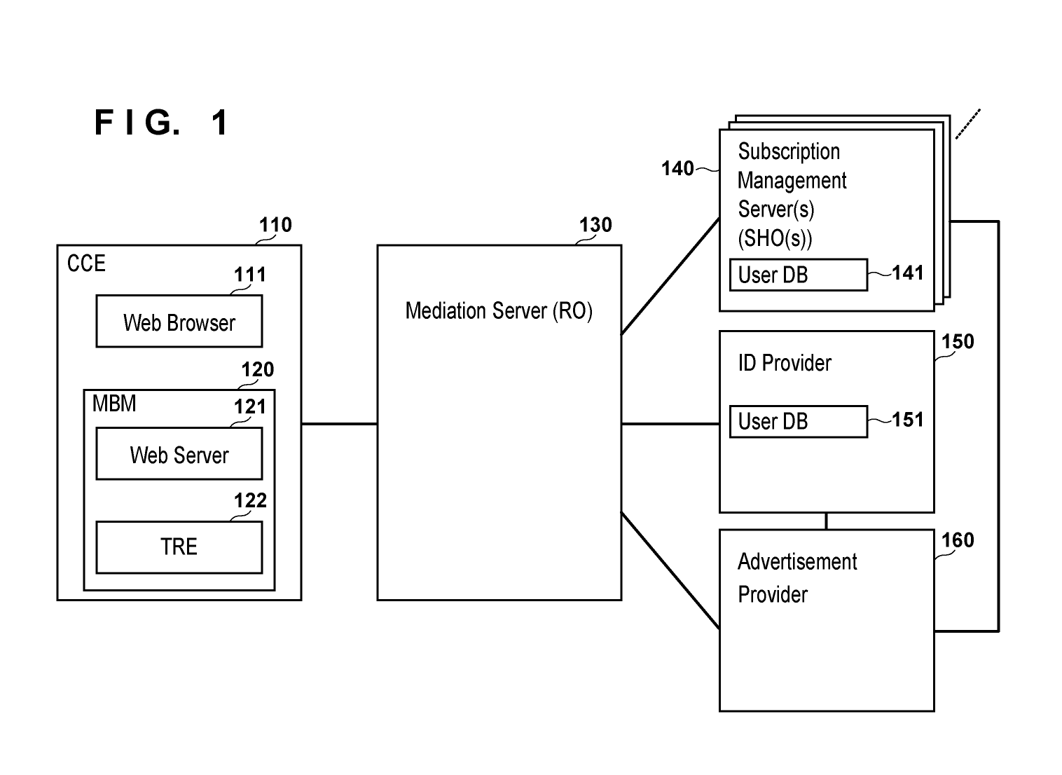

FIG. 1 illustrates an overview of an MCIM provisioning system 100 according to the first embodiment of the present invention. In the MCIM provisioning system 100, a CCE 110 comprises a Web browser 111 and a mobile broadband module (MBM) 120.

The MBM 120 comprises a Web server 121 and a trusted environment (TRE) 122 which stores a PCID, and also comprises a communication interface (not shown) toward a mobile network. The CCE 110 accesses a mediation server 130 by use of the PCID in order to obtain an MCIM and provision it in the TRE 122. The Web server 121 may be implemented in accordance with the OMA Smartcard Web Server specification found at http://www.openmobilealliance.org/technical/release_program/SCWS_v1_{—}0.aspx. Because the MBM 120 comprises the Web server 121, it is possible for the MBM 120 to provide the CCE 110 (in particular, the Web browser 111) with various data or information.

It should be noted that, in the present application, a PCID is also referred to as a “device identity”, because the PCID can be used to identify a CCE.

The mediation server 130 is a server for implementing the functionality of an RO. The mediation server 130 accesses a subscription management server 140 (or more than one subscription management servers 140) in order to mediate the MCIM between the CCE 110 and the subscription management server 140.

The subscription management server 140 is a server associated with an SHO, and provides the CCE 110 with the MCIM associated with the SHO through the mediation server 130. In some embodiments, the subscription management server 140 comprises a user database (DB) 141 which maintains the association between user identities and PCIDs. To be more specific, an owner (e.g., a company) of the CCE 110 subscribes to the subscription management server 140 for the PCID stored in the TRE 122 at an appropriate timing (typically, when the owner purchases the CCE 110). Then, the subscription management server 140 stores user identities of potential users (e.g., the employees of the company) of the CCE 110 in the user DB 141 in association with this PCID. The subscription management server 140 also maintains user credentials for each user identity in the user DB 141. These user credentials may be a password, and will be used as login credentials later. Because the subscription management server 140 maintains the association between user identities and PCIDs in the user DB 141, by inquiring of the subscription management server 140, the mediation server 130 can identify the user identities associated with the PCID received from the CCE 110 during the procedure of MCIM provisioning.

In an alternative embodiment, an identity (ID) provider 150 may maintain the association between user identities and PCIDs, as well as user credentials for each user identity, in a user DB 151. In this case, the owner of the CCE 110 registers the potential users (e.g., the employees of the company) with the ID provider 150 in association with the PCID, and the mediation server 130 inquires of the ID provider 150 of the user identities associated with the PCID received from the CCE 110 during the procedure of MCIM provisioning.

In some embodiments, the mediation server 130 may obtain an advertisement (or information object, to be more general) from an advertisement provider 160. The advertisement may be associated with a PCID or a user identity, either directly, or through the demographic or other characteristic information about the user. In the former case, for example, the advertisement may be optimized for the group of the users of the CCE 110, because the PCID is associated with the subscription or registration made by the owner of the CCE 110. In the latter case, for example, the advertisement may be personalized for a specific user corresponding to a specific user identity. It should be noted that the mediation server 130 may obtain the advertisement from the advertisement provider 160 directly or by way of the subscription management server 140 or the ID provider 150.

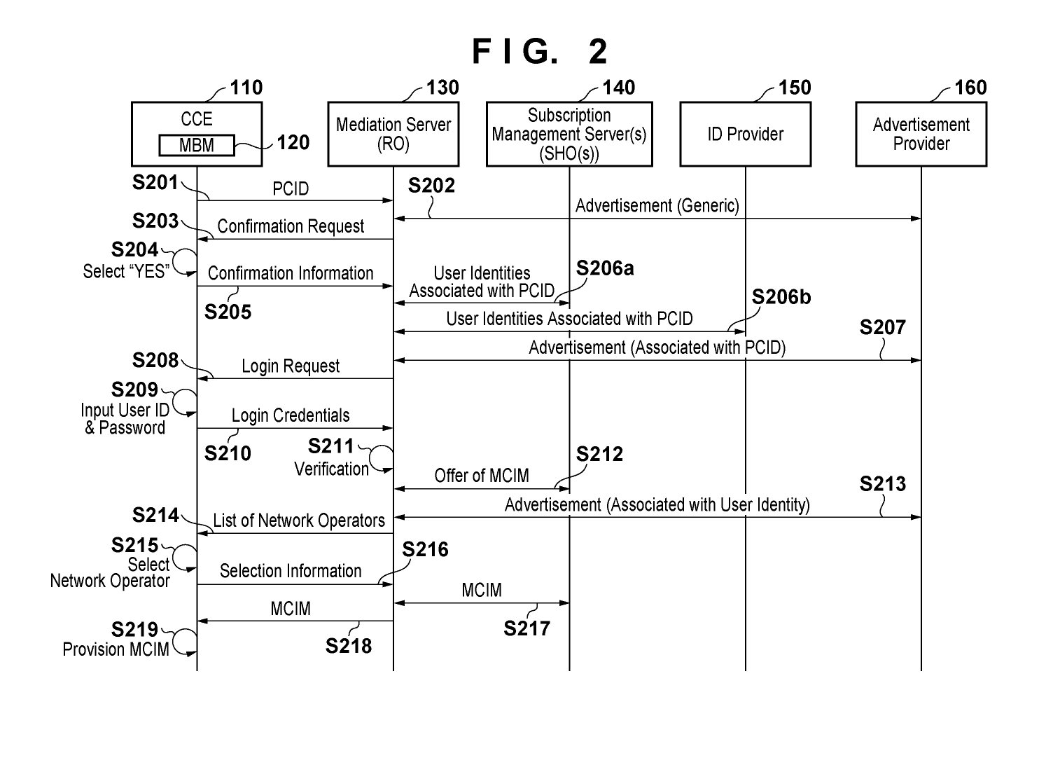

FIG. 2 is a sequence diagram illustrating a procedure of MCIM provisioning according to the first embodiment of the present invention. In the following description, because the MBM 120 is comprised in the CCE 110, in cases where it is not necessary to exactly distinguish the communication between the MBM 120 and the mediation server 130 from the communication between the CCE 110 and the mediation server 130, the communication between the MBM 120 and the mediation server 130 may sometimes be referred to as the communication between the CCE 110 and the mediation server 130. Accordingly, for example, the phrase “the mediation server 130 receives some information from the CCE 110” may refer to the situation that the mediation server 130 receives some information from the MBM 120, depending on the context.

In step S201, the MBM 120 sends the PCID to the mediation server 130 to initiate the procedure of MCIM provisioning.

In step S202, the mediation server 130 obtains an advertisement from the advertisement provider 160. In this step, the advertisement is not personalized or optimized based on a user identity or the PCID. In this sense, the obtained advertisement is generic. It should be noted that the target to be obtained is not limited to an advertisement. More generally, the mediation server 130 may obtain an information object from an information provider.

In step S203, the mediation server 130 sends a confirmation request including the advertisement to the MBM 120. The confirmation request is a request for requesting the CCE 110 to confirm that a user of the CCE 110 wishes to have an MCIM (i.e., to initiate the procedure of MCIM provisioning).

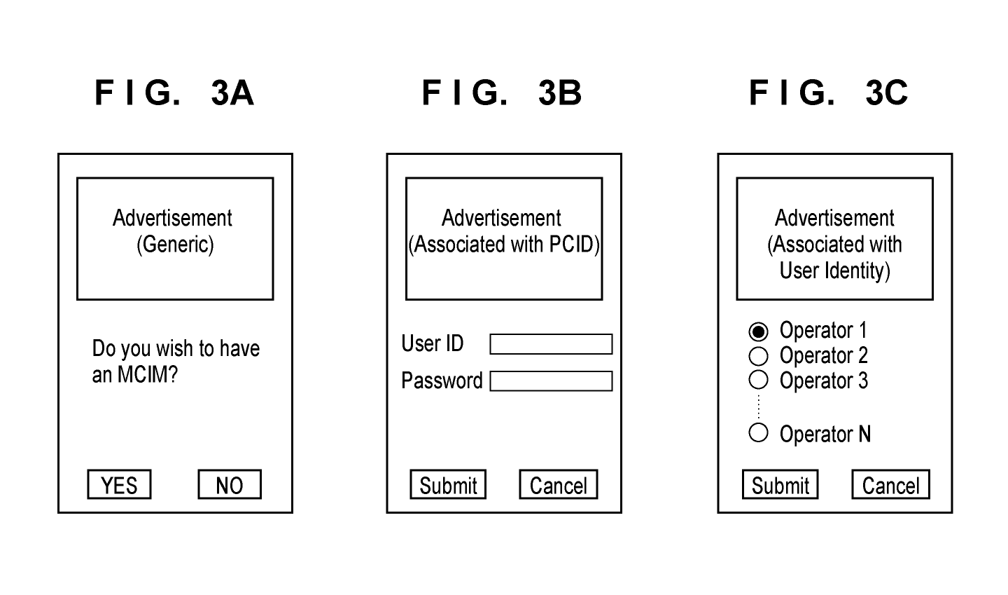

In step S204, the Web server 121 of the MBM 120 sends the confirmation request including the advertisement to the Web browser 111 of the CCE 110. The confirmation request is, for example, sent in the form of an HTML document, and the Web browser 111 displays the confirmation request including the advertisement as shown in FIG. 3A, for example. Because the advertisement is included in the confirmation request, it is expected that the user of the CCE 110 actually sees the advertisement.

In step S205, if the user selects the “YES” button shown in FIG. 3A, the Web server 121 of the MBM 120 sends, to the mediation server 130, confirmation information indicating that the user actually wishes to have an MCIM.

In step S206a or S206b, the mediation server 130 obtains at least one user identity associated with the PCID received in step S201. In one embodiment, as described above, the subscription management server 140 maintains the user identities in the user DB 141 in association with the PCID. In this case, in step S206a, the mediation server 130 obtains the user identities associated with the PCID from the subscription management server 140. In another embodiment, as described above, the ID provider 150 maintains the user identities in the user DB 151 in association with the PCID. In this case, in step S206b, the mediation server 130 obtains the user identities associated with the PCID from the ID provider 150. In step S206a or S206b, the mediation server 130 also obtains user credentials for the user identities from the subscription management server 140 or the ID provider 150. These user credentials may be a password, and will be used as login credentials later.

In some embodiments, the mediation server 130 may select one of the obtained user identities based on certain business criteria in step S206a or S206b. These criteria can involve whether there is a business relationship between the operator of the mediation server 130 and the owner of the system providing the user identity; whether the operator of the mediation server 130 gets remunerated for providing an additional user; whether the ID provider 150 is currently maintaining a campaign which includes offers to the user; etc.

In step S207, the mediation server 130 obtains an advertisement associated with the PCID from the advertisement provider 160. Because the PCID is associated with the potential users (e.g., employees of a company) of the CCE 110, the advertisement associated with the PCID can also be associated with a group of the users of the CCE 110. Accordingly, the advertisement obtained in this step may be optimized for the group of the users of the CCE 110. Moreover, in cases where the mediation server 130 selects one of the user identities in step S206a or S206b, the mediation server 130 may obtain the advertisement associated with the selected user identity. In other words, the advertisement may be personalized for the user associated with the selected user identity.

In step S208, the mediation server 130 sends a login request including the advertisement, which was obtained in step S207, to the MBM 120. The login request is a request for requesting login credentials for one of the user identities obtained in step S206a or S206b.

In step S209, the Web server 121 of the MBM 120 sends the login request including the advertisement to the Web browser 111 of the CCE 110. The login request is, for example, sent in the form of an HTML document, and the Web browser 111 displays the login request including the advertisement as shown in FIG. 3B, for example. Because the advertisement is included in the login request, it is expected that the user of the CCE 110 actually sees the advertisement. The user of the CCE 110 inputs his/her user identity in the “User ID” field. The user also inputs a password for the input user identity as the login credentials in the “Password” field. It should be noted that in cases where the mediation server 130 selects one of the user identities in step S206a or S206b, the “User ID” filed may be replaced by a text showing the selected user identity, and the user can only input the password for the selected user identity.

In step S210, if the user selects the “Submit” button shown in FIG. 3B after inputting the user identity and password, the Web server 121 of the MBM 120 sends, to the mediation server 130, the input user identity and password.

In step S211, the mediation server 130 verifies the received password by comparing it with the password (user credentials) which is associated with the received user identity (or the user identity selected in step S206a or S206b) and which was obtained in step S206a or S206b. As a result of this step, in contrast to the conventional art, the mediation server 130 can identify the user of the CCE 110 during the procedure of MCIM provisioning, even if there are a plurality of potential users associated with the PCID.

In step S212, if the login credentials are successfully verified in step S211, the mediation server 130 asks one or more subscription management servers 140 for offers of MCIMs to the user identified by the user identity received in step S210 (or selected in step S206a or S206b). These subscription management servers 140 may be associated with one or more network operators (SHO), and provide one or more offers from them. The subscription management servers 140 consider the user identity, the subscription associated with the user identity, their capacity, and so on, and generate a suitable offer. Because the subscription management servers 140 are associated with network operators, in this way, the mediation server 130 may identify network operators that offer to provide the CCE 110 with an MCIM.

In step S213, the mediation server 130 obtains an advertisement associated with the user identity received in step S210 (or selected in step S206a or S206b) from the advertisement provider 160. The advertisement obtained in this step may be personalized for the user associated with the user identity.

In step S214, the mediation server 130 sends a list of the network operators, as well as their offers, identified in step S212. The list may include the advertisement obtained in step S213.

In step S215, the Web server 121 of the MBM 120 sends the list including the advertisement to the Web browser 111 of the CCE 110. The list is, for example, sent in the form of an HTML document, and the Web browser 111 displays the list including the advertisement as shown in FIG. 3C, for example. Because the advertisement is included in the list of network operators, it is expected that the user of the CCE 110 actually see the advertisement. The user of the CCE 110 selects one of the network operators through the radio buttons shown in FIG. 3C.

In step S216, if the user selects the “Submit” button shown in FIG. 3C after selecting one of the network operators, the Web server 121 of the MBM 120 sends, to the mediation server 130, selection information indicating the selected network operator.

In step S217, the mediation server 130 obtains an MCIM from the subscription management server 140 associated with the network operator indicated in the selection information received in step S216.

In step S218, the mediation server 130 forwards the obtained MCIM to the MBM 120.

In step S219, the MBM 120 provisions the MCIM in the TRE 122.

As a result of the above procedure, the CCE 110 has an MCIM in the TRE 122 of the MBM 120, and the CCE 110 can connect to a network operated by the network operator associated with the MCIM.

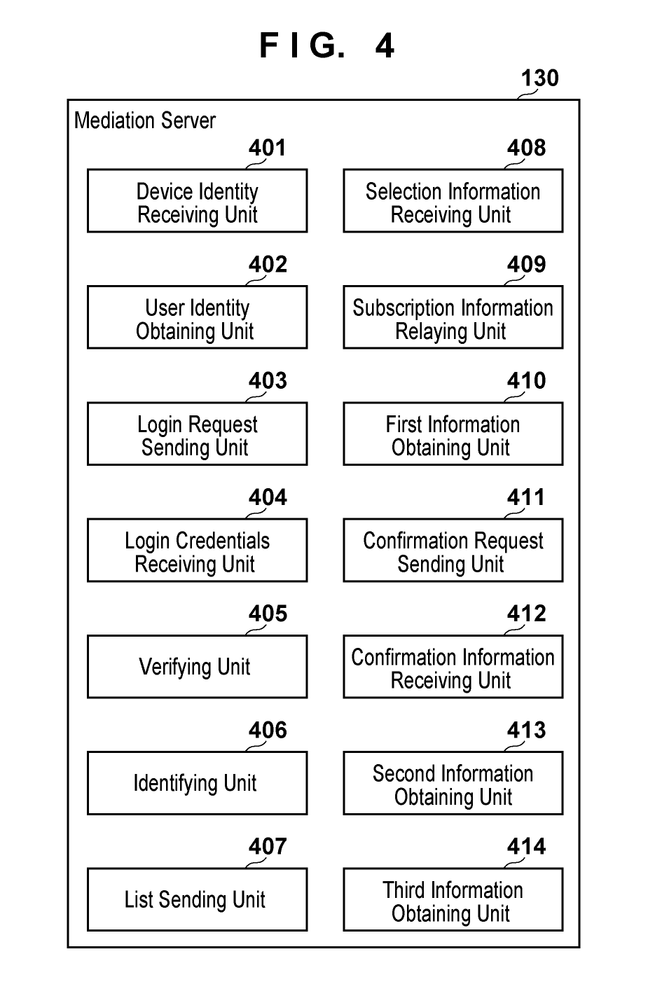

FIG. 4 is a functional block diagram of the mediation server 130 according to the first embodiment of the present invention. The mediation server 130 comprises a device identity receiving unit 401, a user identity obtaining unit 402, a login request sending unit 403, a login credentials receiving unit 404, a verifying unit 405, an identifying unit 406, a list sending unit 407, a selection information receiving unit 408, and a subscription information relaying unit 409.

The device identity receiving unit 401 is configured to receive the PCID in step S201. The user identity obtaining unit 402 is configured to obtain the user identities in step S206a or S206b. The login request sending unit 403 is configured to send the login request in step S208. The login credentials receiving unit 404 is configured to receive the login credentials in step S210. The verifying unit 405 is configured to verify the login credentials in step S211. The identifying unit 406 is configured to identify the network operators in step S217. The list sending unit 407 is configured to send the list in step S214. The selection information receiving unit 408 is configured to receive the selection information in step S216. The subscription information relaying unit 409 is configured to receive the MCIM in step S217 and forward the MCIM in step S218.

The mediation server 130 may also comprise a first information obtaining unit 410, a confirmation request sending unit 411, a confirmation information receiving unit 412, a second information obtaining unit 413, and a third information obtaining unit 414.

The first information obtaining unit 410 is configured to obtain the advertisement in step S202. The confirmation request sending unit 411 is configured to send the confirmation request in step S203. The confirmation information receiving unit 412 is configured to receive the confirmation information in step S205. The second information obtaining unit 413 is configured to obtain the advertisement in step S207. The third information obtaining unit 414 is configured to obtain the advertisement in step S213.

It should be noted that the functionality of each unit in the mediation server 130 may be implemented using dedicated hardware, using software executed by a processor (not shown), or a combination thereof.

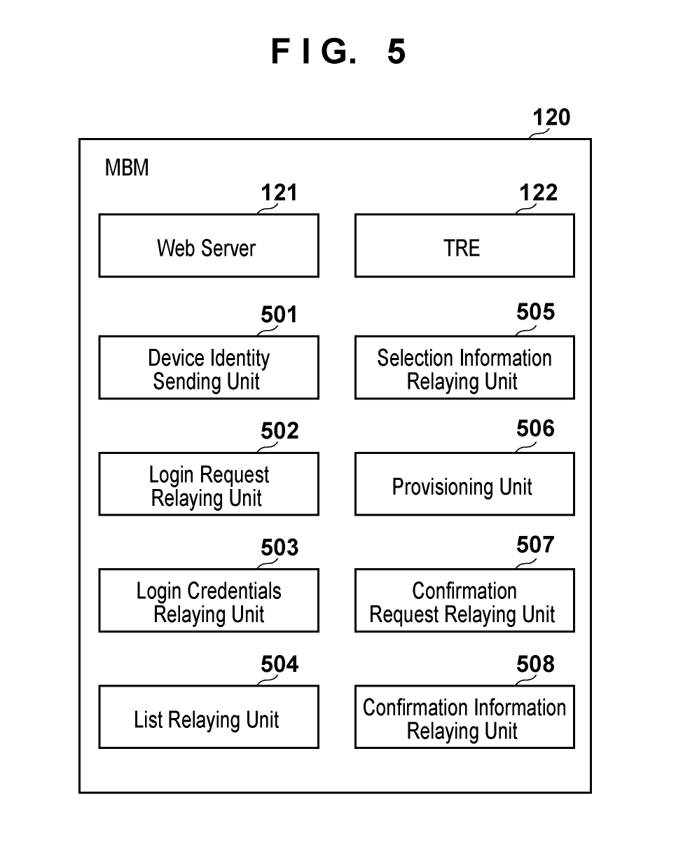

FIG. 5 is a functional block diagram of the MBM 120 according to the first embodiment of the present invention. The MBM 120 comprises the Web server 121, the TRE 122, a device identity sending unit 501, a login request relaying unit 502, a login credentials relaying unit 503, a list relaying unit 504, a selection information relaying unit 505, and a provisioning unit 506.

The device identity sending unit 501 is configured to send the PCID in step S201. The login request relaying unit 502 is configured to receive the login request in step S208 and forward the login request through the Web server 121 in step S209. The login credentials relaying unit 503 is configured to receive the login credentials through the Web server 121 in step S209 and forward the login credentials in step S210. The list relaying unit 504 is configured to receive the list in step S214 and forward the list through the Web server 121 in step S215. The selection information relaying unit 505 is configured to receive the selection information through the Web server 121 in step S215 and forwards the selection information in step S216. The provisioning unit 506 is configured to receive the MCIM in step S218 and provision the MCIM in step S219.

The MBM 120 may also comprise a confirmation request relaying unit 507, and a confirmation information relaying unit 508.

The confirmation request relaying unit 507 is configured to receive the confirmation request in step S203 and forward the confirmation request through the Web server 121 in step S204. The confirmation information relaying unit 508 is configured to receive the confirmation information through the Web server 121 in step S204 and forward the confirmation information in step S205.

It should be noted that the functionality of the Web server 121 and each unit in the MBM 120 may be implemented using dedicated hardware, using software executed by a processor (not shown), or a combination thereof. Moreover, the TRE 122 may be implemented using a memory and software executed by a processor (not shown).

As described above, according to the first embodiment of the present invention, the mediation server 130 or the user selects one of the user identities associated with the PCID in step S206a, S206b, or S209. Then, the mediation server 130 receives the login credentials for the selected user identity in step S210 and verifies the login credentials in step S211.

Accordingly, it is possible for the mediation server 130 to identify the user of the CCE 110 during the procedure of MCIM provisioning, even if there are a plurality of potential users associated with the PCID.

### Second Embodiment

The first embodiment is described in the context of MCIM provisioning according to TR 33.812. However, the concept of the present invention can also be applied to scenarios where an embedded SIM is activated using Over The Air (OTA) provisioning.

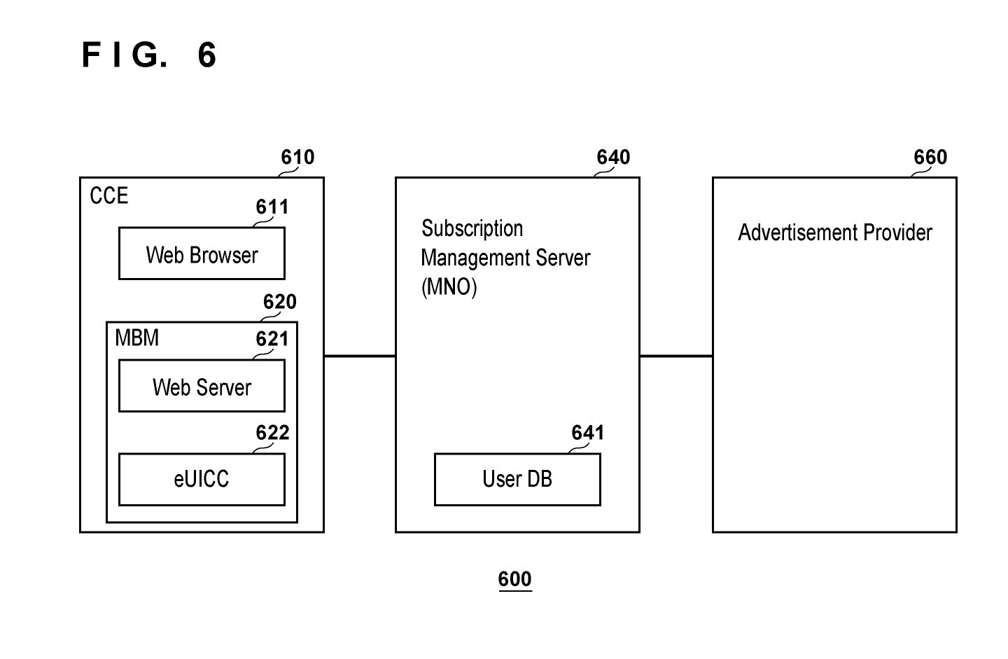

FIG. 6 illustrates an overview of a SIM activating system 600 according to the second embodiment of the present invention. In the SIM activating system 600, a CCE 610 comprises a Web browser 611 and a mobile broadband module (MBM) 620. The MBM 620 comprises a Web server 621 and an embedded Universal Integrated Circuit Card (eUICC) 622 which stores an embedded SIM issued by a network operator associated with a subscription management server 640, and also comprises a communication interface (not shown) toward a mobile network. The CCE 610 tries to connect to a network by use of the embedded SIM as subscription information. The Web server 621 may be implemented in accordance with the OMA Smartcard Web Server specification. Because the MBM 620 comprises the Web server 621, it is possible for the MBM 620 to provide the CCE 610 (in particular, the Web browser 611) with various data or information.

The subscription management server 640 is a server associated with a mobile network operator (MNO) which has issued the embedded SIM. The subscription management server 640 comprises a user database (DB) 641 which maintains the association between user identities and the embedded SIM. To be more specific, an owner (e.g., a company) of the CCE 610 makes subscription to the subscription management server 640 for the embedded SIM at an appropriate timing (typically, when the owner purchases the CCE 610). Then, the subscription management server 640 stores user identities of potential users (e.g., the employees of the company) of the CCE 610 in the user DB 641 in association with this PCID. The subscription management server 640 also maintains user credentials for each user identity in the user DB 641. These user credentials may be a password, and will be used as login credentials later. Because the subscription management server 640 maintains the association between user identities and embedded SIMs in the user DB 641, the subscription management server 640 can identify the user identities associated with the embedded SIM (to be exact, an IMSI) received from the CCE 610 during the procedure of activating the embedded SIM.

In some embodiments, the subscription management server 640 may obtain an advertisement (or information object, to be more general) from an advertisement provider 660. The advertisement may be associated with an embedded SIM or a user identity. In the former case, for example, the advertisement may be optimized for the group of the users of the CCE 610, because the embedded SIM is associated with the subscription made by the owner of the CCE 610. In the latter case, for example, the advertisement may be personalized for a specific user corresponding to a specific user identity.

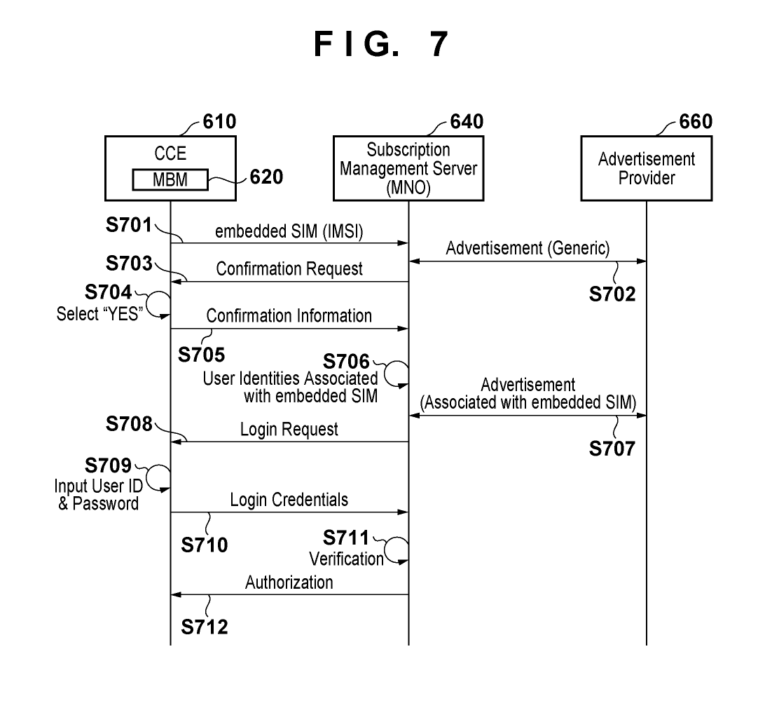

FIG. 7 is a sequence diagram illustrating a procedure of activating an embedded SIM according to the second embodiment of the present invention. In the following description, because the MBM 620 is comprised in the CCE 610, in cases where it is not necessary to exactly distinguish the communication between the MBM 620 and the subscription management server 640 from the communication between the CCE 610 and the subscription management server 640, the communication between the MBM 620 and the subscription management server 640 may sometimes be referred to as the communication between the CCE 610 and the subscription management server 640. Accordingly, for example, the phrase “the subscription management server 640 receives some information from the CCE 610” may refer to the situation that the subscription management server 640 receives some information from the MBM 620, depending on the context.

In step S701, the CCE 610 tries to connect to a network by use of the embedded SIM stored in the eUICC 622 of the MBM 620. The subscription management server 640, which is associated with the network operator that issued the embedded SIM, detects the CCE 610 trying to connect to the network.

In step S702, the subscription management server 640 obtains an advertisement from the advertisement provider 660. In this step, the advertisement is not personalized or optimized based on a user identity or the embedded SIM. In this sense, the obtained advertisement is generic. It should be noted that the target to be obtained is not limited to an advertisement. More generally, the subscription management server 640 may obtain an information object from an information provider.

In step S703, the subscription management server 640 sends a confirmation request including the advertisement to the MBM 620. The confirmation request is a request for requesting the CCE 610 to confirm that a user of the CCE 610 wishes to activate the embedded SIM (i.e., to connect the CCE 610 to the network by use of the embedded SIM).

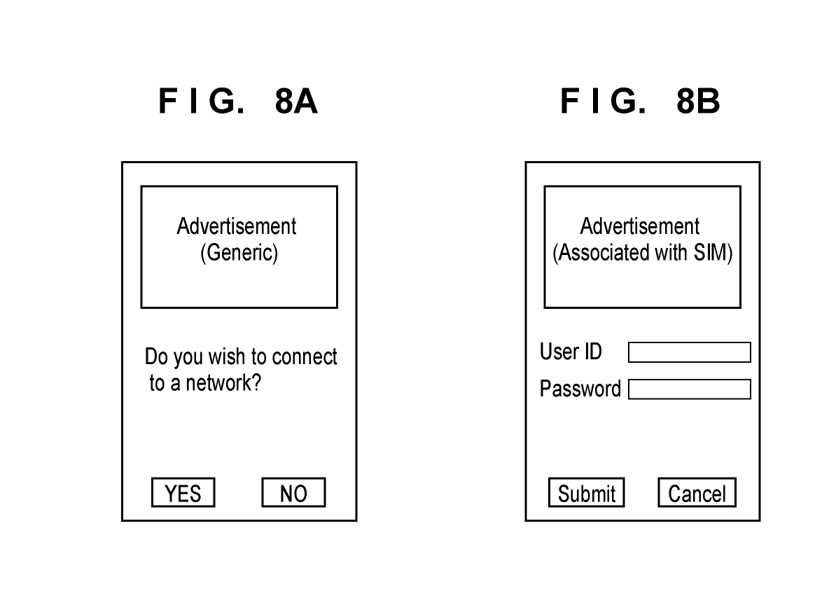

In step S704, the Web server 621 of the MBM 620 sends the confirmation request including the advertisement to the Web browser 611 of the CCE 610. The confirmation request is, for example, sent in the form of an HTML document, and the Web browser 611 displays the confirmation request including the advertisement as shown in FIG. 8A, for example. Because the advertisement is included in the confirmation request, it is expected that the user of the CCE 610 actually see the advertisement.

In step S705, if the user selects the “YES” button shown in FIG. 8A, the Web server 621 of the MBM 620 sends, to the subscription management server 640, confirmation information indicating that the user actually wishes to activate the embedded SIM.

In step S706, the subscription management server 640 obtains, from the user DB 641, at least one user identity associated with the embedded SIM (to be exact, an IMSI) received in step S701.

In some embodiments, the subscription management server 640 may select one of the obtained user identities based on certain business criteria in step S706.

In step S707, the subscription management server 640 obtains an advertisement associated with the embedded SIM from the advertisement provider 660. Because the embedded SIM is associated with the potential users (e.g., employees of a company) of the CCE 610, the advertisement associated with the embedded SIM can also be associated with a group of the users of the CCE 610. Accordingly, the advertisement obtained in this step may be optimized for the group of the users of the CCE 610. Moreover, in cases where the subscription management server 640 selects one of the user identities in step S706, the subscription management server 640 may obtain the advertisement associated with the selected user identity. In other words, the advertisement may be personalized for the user associated with the selected user identity.

In step S708, the subscription management server 640 sends a login request including the advertisement, which was obtained in step S707, to the MBM 620. The login request is a request for requesting login credentials for one of the user identities obtained in step S706.

In step S709, the Web server 621 of the MBM 620 sends the login request including the advertisement to the Web browser 611 of the CCE 610. The login request is, for example, sent in the form of an HTML document, and the Web browser 611 displays the login request including the advertisement as shown in FIG. 8B, for example. Because the advertisement is included in the login request, it is expected that the user of the CCE 610 actually see the advertisement. The user of the CCE 610 inputs his/her user identity in the “User ID” field. The user also inputs a password for the input user identity as the login credentials in the “Password” field. It should be noted that in cases where the subscription management server 640 selects one of the user identities in step S706, the “User ID” filed may be replaced by a text showing the selected user identity, and the user can only input the password for the selected user identity.

In step S710, if the user selects the “Submit” button shown in FIG. 8B after inputting the user identity and password, the Web server 621 of the MBM 620 sends, to the subscription management server 640, the input user identity and password.

In step S711, the subscription management server 640 verifies the received password by comparing it with the password (user credentials) which is associated with the received user identity (or the user identity selected in step S706) and which is stored in the user DB 641. As a result of this step, in contrast to the conventional art, the subscription management server 640 can identify the user of the CCE 610 during the procedure of activating an embedded SIM, even if there are a plurality of potential users associated with the embedded SIM.

In step S712, if the login credentials are successfully verified in step S711, the subscription management server 640 authorizes the CCE 610 to connect to the network by use of the embedded SIM stored in the eUICC 622 of the MBM 620.

As a result of the above procedure, the embedded SIM stored in the eUICC 622 of the MBM 620 is activated, and the CCE 610 can now connect to the network operated by the network operator associated with the embedded SIM.

In the above procedure, the communication between MBM 620 and the subscription management server 640 may be performed through, for example, a Short Message Service message, an IP message, an Unstructured Supplementary Service Data message, a Wireless Messaging Teleservice message, a Wireless Enhanced Messaging Teleservice message, an Enhanced Messaging Service message, or a Multimedia Messaging Service message.

In an alternative embodiment, the CCE 610 contains pre-installed various advertisements. In this case, the confirmation request and the login request may not include the advertisement, and may instead include an advertisement identity (such as a numerical value) identifying a specific advertisement. In this case, in steps S704 and S709, the Web server 621 inserts the advertisement corresponding to the advertisement identity. This alternative embodiment is advantageous because it is not necessary to transfer a bandwidth-consuming advertisement from the subscription management server 640 to the CCE 610.

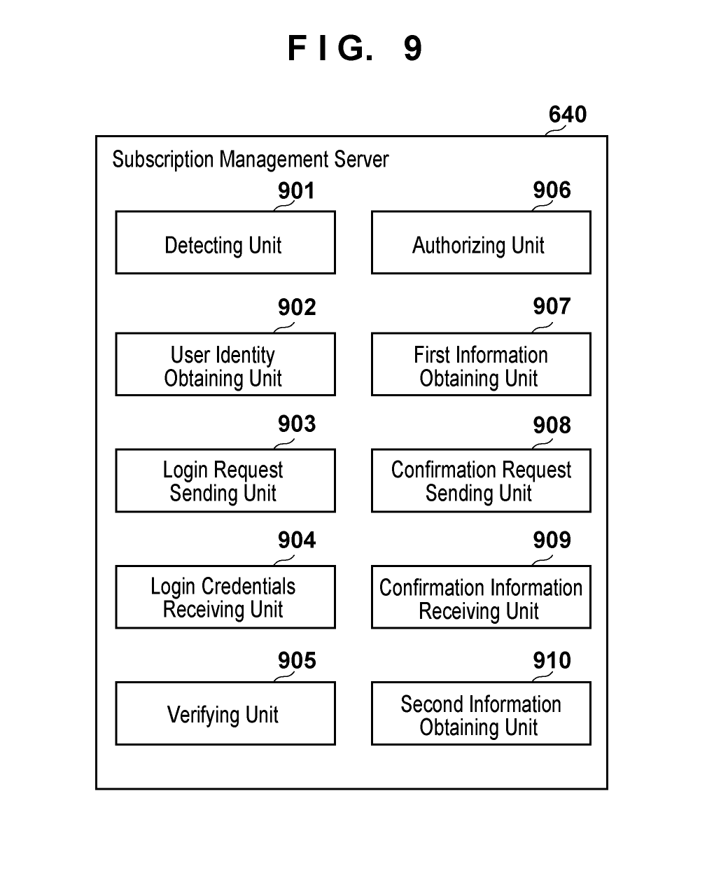

FIG. 9 is a functional block diagram of the subscription management server 640 according to the second embodiment of the present invention. The subscription management server 640 comprises a detecting unit 901, a user identity obtaining unit 902, a login request sending unit 903, a login credentials receiving unit 904, a verifying unit 905, and an authorizing unit 906.

The detecting unit 901 is configured to detect the CCE 610 trying to connect to the network in step S701. The user identity obtaining unit 902 is configured to obtain the user identities in step S706. the login request sending unit 903 is configured to send the login request in step S708. The login credentials receiving unit 904 is configured to receive the login credentials in step S710. The verifying unit 905 is configured to verify the login credentials in step S711. The authorizing unit 906 is configured to authorize the CCE 610 to connect to the network by use of the embedded SIM in step S712.

The subscription management server 640 may also comprise a first information obtaining unit 907, a confirmation request sending unit 908, a confirmation information receiving unit 909, and a second information obtaining unit 910.

The first information obtaining unit 907 is configured to obtain the advertisement in step S702. The confirmation request sending unit 908 is configured to send the confirmation request in step S703. The confirmation information receiving unit 909 is configured to receive the confirmation information in step S705. The second information obtaining unit 910 is configured to obtain the advertisement in step S707.

It should be noted that the functionality of each unit in the subscription management server 640 may be implemented using dedicated hardware, using software executed by a processor (not shown), or a combination thereof.

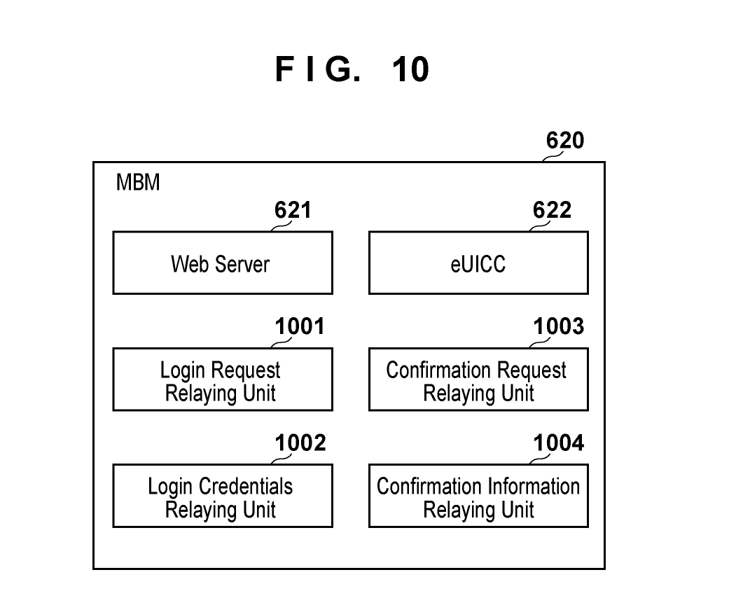

FIG. 10 is a functional block diagram of the MBM 620 according to the second embodiment of the present invention. The MBM 620 comprises the Web server 621, the eUICC 622, a login request relaying unit 1001, and a login credentials relaying unit 1002.

The login request relaying unit 1001 is configured to receive the login request in step S708 and forward the login request through the Web server 621 in step S709. The login credentials relaying unit 1002 is configured to receive the login credentials through the Web server 621 in step S709 and forward the login credentials in step S710.

The MBM 620 may also comprise a confirmation request relaying unit 1003 and a confirmation information relaying unit 1004.

The confirmation request relaying unit 1003 is configured to receive the confirmation request in step S703 and forward the confirmation request through the Web server 621 in step S704. The confirmation information relaying unit 1004 is configured to receive the confirmation information through the Web server 621 in step S704 and forward the confirmation information in step S705.

It should be noted that the functionality of the Web server 621 and each unit in the MBM 620 may be implemented using dedicated hardware, using software executed by a processor (not shown), or a combination thereof. Moreover, the eUICC 622 may be implemented using a memory and software executed by a processor (not shown).

As described above, according to the second embodiment of the present invention, the subscription management server 640 or the user selects one of the user identities associated with the embedded SIM in step S706 or S709. Then, the subscription management server 640 receives the login credentials for the selected user identity in step S710 and verifies the login credentials in step S711.

Accordingly, it is possible for the subscription management server 640 to identify the user of the CCE 610 during the procedure of activating the embedded SIM, even if there are a plurality of potential users associated with the embedded SIM.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1-25. (canceled)

26. A mediation server comprising:
a device identity receiving unit configured to receive, from a communication device, a device identity which enables the communication device to connect to a network operated by a network operator associated with the mediation server;
a user identity obtaining unit configured to obtain at least one user identity associated with the device identity;
a login request sending unit configured to send, to the communication device, a login request for requesting login credentials for one of the at least one user identity;
a login credentials receiving unit configured to receive the login credentials from the communication device;
a verifying unit configured to verify the login credentials by comparing the login credentials with login credentials associated with said one of the at least one user identity;
an identifying unit configured to, if the login credentials are successfully verified, identify, based on said one of the at least one user identity, network operators that offer to provide the communication device with subscription information which enables the communication device to connect to a network operated by the network operator;
a list sending unit configured to send a list of the identified network operators to the communication device;
a selection information receiving unit configured to receive selection information indicating one of the network operators in the list from the communication device; and
a subscription information relaying unit configured to obtain subscription information for use by the communication device from the network operator indicated by the selection information, and forward the obtained subscription information to the communication device.

27. The mediation server according to claim 26, further comprising:
a first information obtaining unit configured to obtain a first information object;
a confirmation request sending unit configured to send a confirmation request including the first information object to the communication device, the confirmation request being a request for requesting the communication device to confirm that a user of the communication device wishes to have subscription information; and
a confirmation information receiving unit configured to receive, from the communication device, confirmation information indicating that the user of the communication device wishes to have subscription information, and
wherein the login request sending unit sends the login request after the confirmation information receiving unit receives the confirmation information.

28. The mediation server according to claim 26, further comprising a second information obtaining unit configured to obtain a second information object associated with the device identity, wherein the login request sending unit includes the second information object in the login request to be sent to the communication device.

29. The mediation server according to claim 26, further comprising a third information obtaining unit configured to obtain a third information object associated with said one of the at least one user identity, wherein the list sending unit includes the third information object in the list to be sent to the communication device.

30. The mediation server according to claim 26, wherein the user identity obtaining unit obtains the at least one user identity from an identity provider which maintains the at least one user identity in association with the device identity.

31. The mediation server according to claim 26, wherein the user identity obtaining unit obtains the at least one user identity from a network operator which maintains the at least one user identity in association with the device identity.

32. The mediation server according to claim 26, wherein said one of the at least one user identity is decided by a user of the communication device in response to the login request, and the login credentials receiving unit receives user identity information indicating the decided user identity.

33. A method for controlling a mediation server, comprising:
a device identity receiving step of receiving, from a communication device, a device identity which enables the communication device to connect to a network operated by a network operator associated with the mediation server;
a user identity obtaining step of obtaining at least one user identity associated with the device identity;
a login request sending step of sending, to the communication device, a login request for requesting login credentials for one of the at least one user identity;
a login credentials receiving step of receiving the login credentials from the communication device;
a verifying step of verifying the login credentials by comparing the login credentials with login credentials associated with said one of the at least one user identity;
an identifying step of, if the login credentials are successfully verified, identifying, based on said one of the at least one user identity, network operators that offer to provide the communication device with subscription information which enables the communication device to connect to a network operated by the network operator;
a list sending step of sending a list of the identified network operators to the communication device;
a selection information receiving step of receiving selection information indicating one of the network operators in the list from the communication device; and
a subscription information relaying step of obtaining subscription information for use by the communication device from the network operator indicated by the selection information, and forwarding the obtained subscription information to the communication device.

34. A subscription information managing apparatus for use in a communication device, comprising:
a subscription information maintaining unit configured to store a device identity which enables the communication device to connect to a network operated by a network operator associated with a mediation server;
a device identity sending unit configured to send the device identity to the mediation server;
a login request relaying unit configured to receive, from the mediation server, a login request for requesting login credentials for a certain user identity associated with the device identity, and forward the received login request to the communication device;
a login credentials relaying unit configured to receive the login credentials from the communication device, and forward the received login credentials to the mediation server;
a list relaying unit configured to receive, from the mediation server, a list of network operators identified by the mediation server based on said certain user identity, and forward the list to the communication device;
a selection information relaying unit configured to receive, from the communication device, selection information indicating one of the network operators in the list, and forward the received selection information to the mediation server; and
a provisioning unit configured to receive, from the mediation server, subscription information which enables the communication device to connect to a network operated by the network operator indicated by the selection information, and provision the received subscription information in the subscription information maintaining unit.

35. The subscription information managing apparatus according to claim 34, further comprising:
a confirmation request relaying unit configured to receive a confirmation request including a first information object from the mediation server, and forward the confirmation request to the communication device, the confirmation request being a request for requesting the communication device to confirm that a user of the communication device wishes to have subscription information; and
a confirmation information relaying unit configured to receive, from the communication device, confirmation information indicating that the user of the communication device wishes to have subscription information, and forward the confirmation information to the mediation server,
wherein the login request relaying unit receives the login request after the confirmation information relaying unit forwards the confirmation information to the mediation server.

36. The subscription information managing apparatus according to claim 34, wherein the login request received and forwarded by the login request relaying unit includes a second information object associated with the device identity.

37. The subscription information managing apparatus according to claim 34, wherein the list received and forwarded by the list relaying unit includes a third information object associated with said certain user identity.

38. The subscription information managing apparatus according to claim 34, wherein the login credentials relaying unit receives, from the communication device, user identity information indicating a user identity decided as said certain user identity, and forwards the user identity information to the mediation server.

39. A method for controlling subscription information managing apparatus for use in a communication device, the subscription information managing apparatus having a subscription information maintaining unit configured to store a device identity which enables the communication device to connect to a network operated by a network operator associated with a mediation server, the method comprising:
a device identity sending step of sending the device identity to the mediation server;
a login request relaying step of receiving, from the mediation server, a login request for requesting login credentials for a certain user identity associated with the device identity, and forwarding the received login request to the communication device;
a login credentials relaying step of receiving the login credentials from the communication device, and forwarding the received login credentials to the mediation server;
a list relaying step of receiving, from the mediation server, a list of network operators identified by the mediation server based on said certain user identity, and forwarding the list to the communication device;
a selection information relaying step of receiving, from the communication device, selection information indicating one of the network operators in the list, and forwarding the received selection information to the mediation server; and
a provisioning step of receiving, from the mediation server, subscription information which enables the communication device to connect to a network operated by the network operator indicated by the selection information, and provisioning the received subscription information in the subscription information maintaining unit.

40. A subscription management server comprising:
a detecting unit configured to detect a communication device which tries to connect to a network by use of subscription information issued by a network operator associated with the subscription management server;
a user identity obtaining unit configured to obtain at least one user identity associated with the subscription information;
a login request sending unit configured to send, to the communication device, a login request for requesting login credentials for one of the at least one user identity;
a login credentials receiving unit configured to receive the login credentials from the communication device;
a verifying unit configured to verify the login credentials by comparing the login credentials with login credentials associated with said one of the at least one user identity; and
an authorizing unit configured to, if the login credentials are successfully verified, authorize the communication device to connect to the network by use of the subscription information.

41. The subscription management server according to claim 40, further comprising:
a first information obtaining unit configured to obtain a first information object;
a confirmation request sending unit configured to send a confirmation request including the first information object to the communication device, the confirmation request being a request for requesting the communication device to confirm that a user of the communication device wishes to connect the communication device to the network by use of the subscription information; and
a confirmation information receiving unit configured to receive, from the communication device, confirmation information indicating that the user of the communication device wishes to connect the communication device to the network by use of the subscription information,
wherein the login request sending unit sends the login request after the confirmation information receiving unit receives the confirmation information.

42. The subscription management server according to claim 40, further comprising a second information obtaining unit configured to obtain a second information object associated with the subscription information,
wherein the login request sending unit includes the second information object in the login request to be sent to the communication device.

43. The subscription management server according to claim 40, wherein said one of the at least one user identity is decided by a user of the communication device in response to the login request, and the login credentials receiving unit receives user identity information indicating the decided user identity.

44. The subscription management server according to claim 40, wherein the login request is sent and the login credentials are received through a Short Message Service message, an IP message, an Unstructured Supplementary Service Data message, a Wireless Messaging Teleservice message, a Wireless Enhanced Messaging Teleservice message, an Enhanced Messaging Service message, or a Multimedia Messaging Service message.

45. A method for controlling a subscription management server, the method comprising:
a detecting step of detecting a communication device which tries to connect to a network by use of subscription information issued by a network operator associated with the subscription management server;
a user identity obtaining step of obtaining at least one user identity associated with the subscription information;
a login request sending step of sending, to the communication device, a login request for requesting login credentials for one of the at least one user identity;
a login credentials receiving step of receiving the login credentials from the communication device;
a verifying step of verifying the login credentials by comparing the login credentials with login credentials associated with said one of the at least one user identity; and
an authorizing step of, if the login credentials are successfully verified, authorizing the communication device to connect to the network by use of the subscription information.

46. A subscription information managing apparatus for use in a communication device, comprising:
a subscription information maintaining unit configured to store subscription information issued by a network operator associated with a subscription management server;
a login request relaying unit configured to receive, from the subscription management server, a login request for requesting login credentials for a certain user identity associated with the subscription information, and forward the received login request to the communication device; and
a login credentials relaying unit configured to receive the login credentials from the communication device, and forward the received login credentials to the subscription management server.

47. The subscription information managing apparatus according to claim 46, further comprising:
a confirmation request relaying unit configured to receive a confirmation request including a first information object from the subscription management server, and forward the confirmation request to the communication device, the confirmation request being a request for requesting the communication device to confirm that a user of the communication device wishes to connect the communication device to a network operated by the network operator by use of the subscription information; and
a confirmation information relaying unit configured to receive, from the communication device, confirmation information indicating that the user of the communication device wishes to connect the communication device to the network by use of the subscription information, and forward the confirmation information to the subscription management server,
wherein the login request relaying unit receives the login request after the confirmation information relaying unit forwards the confirmation information to the subscription management server.

48. The subscription information managing apparatus according to claim 46, wherein the login request received and forwarded by the login request relaying unit includes a second information object associated with the subscription information.

49. The subscription information managing apparatus according to claim 46, wherein the login credentials relaying unit receives, from the communication device, user identity information indicating a user identity decided as said certain user identity, and forwards the user identity information to the subscription management server.

50. A method for controlling a subscription information managing apparatus for use in a communication device, the subscription information managing apparatus having a subscription information maintaining unit configured to store subscription information issued by a network operator associated with a subscription management server, the method comprising:
a login request relaying step of receiving, from the subscription management server, a login request for requesting login credentials for a certain user identity associated with the subscription information, and forwarding the received login request to the communication device; and
a login credentials relaying step of receiving the login credentials from the communication device, and forwarding the received login credentials to the subscription management server.
